(19) United States
(12) Patent Application Publication
(10) Pub. No.: US 2014/0064823 A1
(43) Pub. Date: Mar. 6, 2014

(54) HARNESS FOR ELECTRONIC DEVICES

(71) Applicant: Terese Benefield, Fayetteville, GA (US)

(72) Inventor: Terese Benefield, Fayetteville, GA (US)

(21) Appl. No.: 13/975,887

(22) Filed: Aug. 26, 2013

Related U.S. Application Data
(60) Provisional application No. 61/693,860, filed on Aug. 28, 2012.

(51) Int. Cl. B42F 5/00

(52) U.S. Cl. CPC B42F 5/00
USPC 402/4

(57) ABSTRACT

A harness for electronic devices includes a folder member and a pouch member. In a preferred embodiment, the folder member is releasably securable to the pouch member and includes an interior pocket and a transparent front cover structured and disposed for allowing a user to operate the touch screen interface of an electronic tablet while the tablet is protectively contained within the interior pocket. The opening of the interior pocket is at least partially sealable. The pouch member includes at least one interior compartment being sized and configured for securing electronic devices. A removable clip extension is provided on the pouch member for releasably securing items. At least one securing strap is provided on the folder member for securing the folder member and pouch member to the cover of a notebook binder.

This non-provisional patent application is based on provisional patent application Ser. No. 61/693,860 filed Aug. 28, 2012.

### BACKGROUND OF THE INVENTION

1. Field of the Invention

This invention relates to storage of electronic devices and, more particularly, to a harness which provides for storage of a first electronic device and a second electronic device, and is adapted for attachment to a notebook binder.

2. Discussion of the Related Art

Students often carry various portable electronic devices while at school for both personal and educational use. In particular, students are more frequently being required to carry an electronic tablet having textbook applications in lieu of individual textbooks. A common problem associated with young students carrying electronic tablets is the tendency of the students to damage or misplace their electronic tablet due to the lack of an easily accessible storage compartment that will protect the electronic tablet from being scratched or otherwise damaged.

Notwithstanding the numerous types of laptop computer cases and electronic tablet cases which have been proposed in the past, there remains a need for a harness for securing multiple electronic devices, such as electronic tablets, e-Readers, cell phones and netbook computers, which is easily accessible by a student. More particularly, there is a need for a harness for securing electronic devices that is adapted for attachment to the cover of a notebook binder, which is commonly utilized by students for organizing notes, assignments, and other papers.

### Objects and Advantages of the Invention

With the foregoing in mind, it is primary object of the present invention to provide a harness for electronic devices that is adapted for attachment to the cover of a binder.

It is a further object of the present invention to provide a harness for electronic devices that includes multiple pockets for securing different portable electronic devices at the same time.

It is still a further object of the present invention to provide a harness for electronic devices that includes a protective lining on the inside of each of the multiple pockets for preventing the stored electronic device from being scratched when stored therein.

It is still a further object of the present invention to provide a harness for electronic devices that is inexpensive to manufacture.

It is still a further object of the present invention to provide a harness for electronic devices that is easily manufactured.

These and other objects and advantages of the present invention are more readily apparent with reference to the following detailed description and the accompanying drawings.

### SUMMARY OF THE INVENTION

The present invention is directed to a harness for electronic devices having a folder member and a pouch member. The folder member includes an interior pocket that is sized and configured for holding a portable electronic device, such as an electronic tablet or a netbook computer. The opening of the interior pocket is at least partially sealable. In a preferred embodiment, the folder member includes a transparent front cover that is structured to allow a user to operate an electronic tablet while the tablet is secured in the folder member. The pouch member may include one or more interior compartments sized and configured for securing electronic devices, such as an e-Reader, a cell phone, a portable media player and a wall charger, as well as non-electronic devices, such as a wallet. In a preferred embodiment, the pouch member is releasably secured to the folder member by fasteners. A removable clip extension may be provided on the harness for releasably securing items such as a flash memory drive, a key chain, or a student identification card. In a preferred embodiment, at least one securing strap is provided for securing the harness to the cover of a notebook binder. In an alternative embodiment, at least one securing strap is provided on the pouch member for securing the pouch member and folder member to the cover of a binder in one of four configurations, wherein the folder member may be interchangeably secured on the outer or inner face of the cover and the pouch member may be secured on the outer or inner face of the cover.

### BRIEF DESCRIPTION OF THE DRAWINGS

For a fuller understanding of the present invention, reference should be made to the following detailed description taken in conjunction with the accompanying drawings in which:

FIG. 1 is a front elevational view of the harness for electronic devices of the present invention and illustrating the folder member, pouch member, and electronic devices shown in broken lines;

FIG. 2 is a side elevational view of the harness for electronic devices of the present invention and illustrating the movement of the pouch member;

FIG. 3 is a perspective view of the harness secured to the front cover of a binder;

FIG. 4 is a rear elevational view of the harness for electronic devices of the present invention;

FIG. 5 is a perspective view of an alternative embodiment of the folder member illustrating the opening of the interior pocket;

FIG. 6 is an elevated front side view of an alternative embodiment of the pouch member and illustrating first and second interior compartments, a removable clip extension, and securing straps;

FIG. 7 is a perspective view of an alternative embodiment of the harness for electronic devices secured to the cover of a binder, wherein the folder member and the pouch member are secured to the inner facing side of the notebook binder; and

FIG. 8 is a perspective view of an alternative embodiment of the harness for electronic devices illustrating an alternative configuration for securing the harness to the cover of a binder, wherein the folder member is secured to the inner facing side of the binder cover and the pouch member is secured to the outer facing side of the binder cover.

Like reference numerals refer to like parts throughout the several views of the drawings.

### DETAILED DESCRIPTION OF THE PREFERRED EMBODIMENTS

Referring to the several views of the drawings, the harness for electronic devices of the present invention is shown in accordance with several preferred embodiments and provided for secured attachment to the cover 100 of a notebook or binder 102. In each of the drawing figures, the harness is generally indicated as 10.

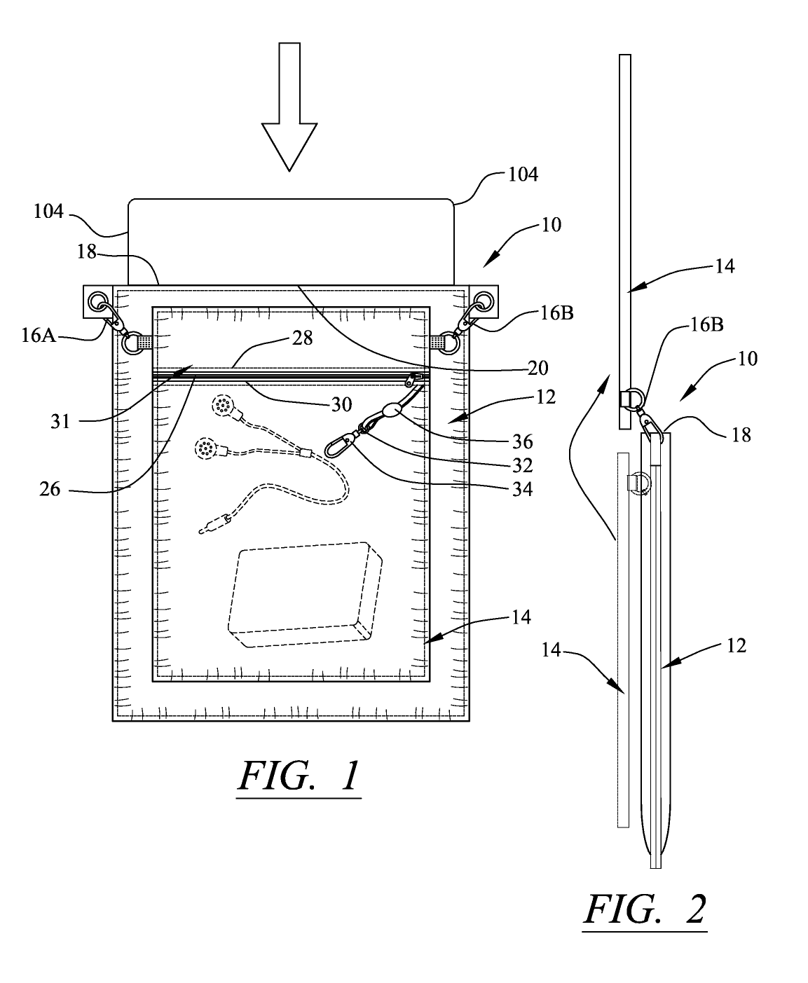

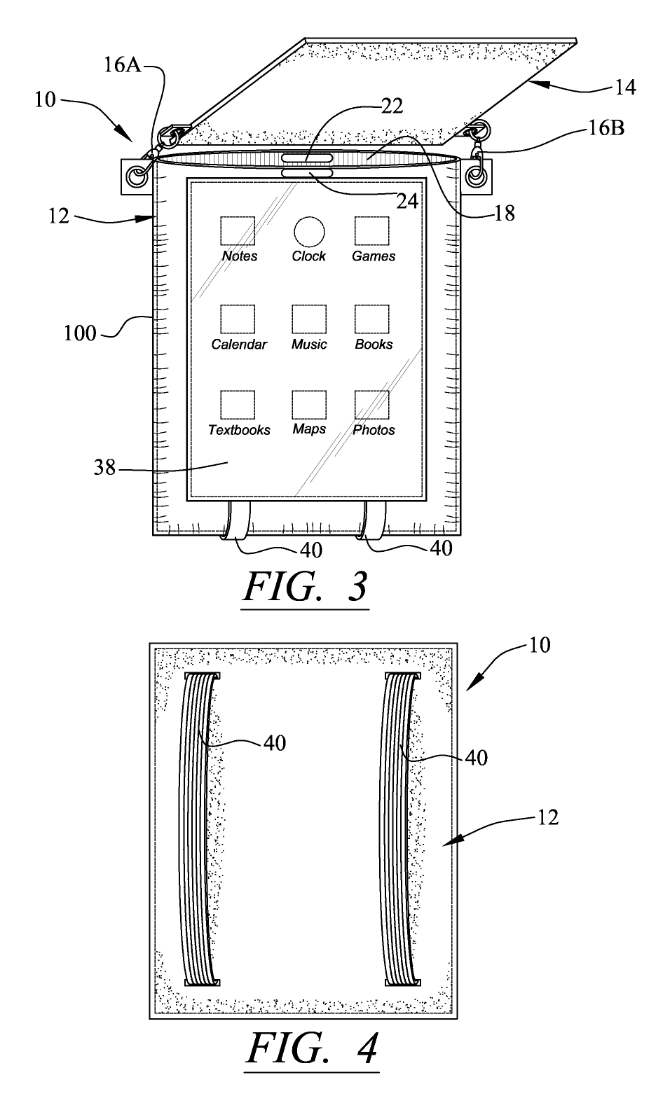

Referring to FIG. 1, the harness 10 for electronic devices includes a folder member 12 and a detachable pouch member 14. The folder member 12 is releasably attached to the pouch member 14 by fasteners 16A and 16B, such as snap fasteners or clasp fasteners. The folder member 12 includes an opening 18 allowing access to an interior pocket 20 that is sized for enveloping a portable electronic device 104, such as an electronic tablet or a netbook computer. The inner facing sides of the interior pocket 20 are preferably lined with felt, silk or other material which will not scratch the portable electronic device stored therein. The top opening 18 of the interior pocket 20 is at least partially sealable using a first segment 22 of a hook and loop fastener and a second mating segment 24 of the hook and loop fastener (shown in FIG. 3). In a preferred embodiment, the front cover 100 of the folder member 12 is at least partially comprised of a transparent material, providing a window 38 (as shown in FIG. 3) that allows a user to operate the touch screen interface of an electronic tablet 104 stored in the interior pocket 20. Specifically, the user can view the touch sensitive display through the transparent window 38 and touch the exterior surface of the transparent window to operate the electronic tablet 104.

The pouch member 14 includes a pouch opening 26 that is at least partially sealable using a first segment 28 of a hook and loop fastener and a second mating segment 30 of the hook and loop fastener. An interior storage compartment 31 of the pouch member 14 is sized and configured for securing electronic devices, such as a cell phone, an e-Reader, a wall charger, headphones, and/or a number of non-electronic devices, such as a wallet. Similar to the interior pocket 20 on the folder member 12, the inner facing sides of the interior storage compartment 31 are preferably lined with felt, silk or other material which will not scratch the portable electronic device stored therein.

In a preferred embodiment, a removable clip extension 32 extends from the folder member 12 and is provided for releasably securing an appropriately sized item, such as a flash memory drive, a key chain, or a student identification card using clasp 34. The clip extension 32 is removable, as may be required by the user, by releasing the fastening member 36 from the locked position.

Referring to FIGS. 2 and 3, the pouch member 14 may be moved away from the folder member 12 to expose the screen of an electronic tablet 104 through the transparent window 38 of the folder member 12. The pouch member 14 may remain attached to the folder member 12, as shown in FIG. 2 or, alternatively, the pouch member 14 may be separated from the folder member 12 by releasing fasteners 16A and 16B.

Referring to FIG. 4, the harness 10 is attachable to a notebook or binder 102 (as shown in FIG. 3) using securing straps 40. In a preferred embodiment, the securing straps 40 are made of an elastic material sized to stretch around a portion of the binder 102 and hold the harness 10 adjacent to the inside or outside cover 100 of the binder 102. In an alternative embodiment, the securing straps 40 may include first and second portions that are releasably attachable using a first segment of a hook and loop fastener on the first portion and a second mating segment of the hook and loop fastener on the second portion. In the alternative embodiment of the securing straps 40, it is preferable that the securing straps 40 be at least partially elastomeric.

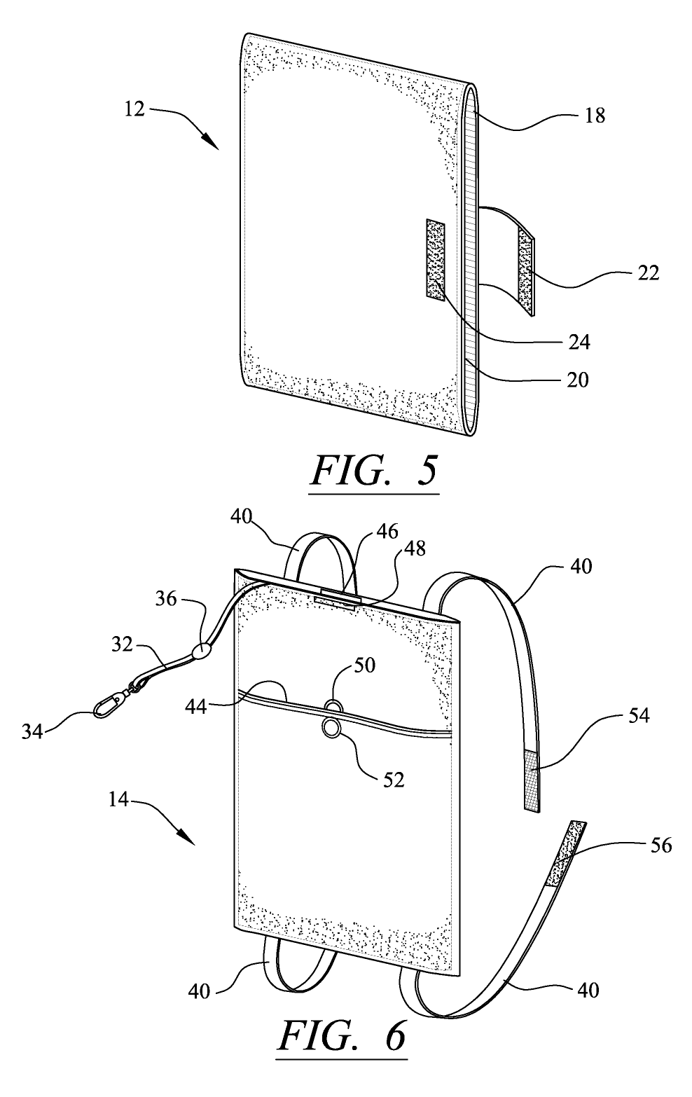

FIGS. 5-7 illustrate an alternative embodiment of the harness 10. Referring specifically to FIG. 5, the folder member 12 includes an opening 18 to an interior pocket 20 that is sized for enveloping a portable electronic device, such as an electronic table or a netbook computer. The inner facing sides of the interior pocket 20 are preferably lined with felt, silk or other material which will not scratch the portable electronic device stored therein. The opening 18 of the pocket 20 is at least partially sealable using a first segment 22 of a hook and loop fastener and a second mating segment 24 of the hook and loop fastener.

Referring to FIG. 6, the pouch member 14 includes a first pouch 42 and a second pouch 44. The first pouch 42 has an opening that is at least partially sealable using a first segment 46 of a hook and loop fastener and a second mating segment 48 of the hook and loop fastener. The first pouch 42 is sized and configured for containing an e-Reader and/or a number of non-electronic devices, such as a wallet. The second pouch 44 has an opening that is at least partially sealable using a first fastener 50 and a second mating fastener 52, which may have reciprocal magnetic properties for promoting ease of sealing the second pouch 44. The second pouch 44 is sized and configured for containing (i.e. holding) electronic devices 104 such as a cell phone, a portable media, and a wall charger. Similar to the interior pocket 20 on the folder member 12, the inner facing sides of the first and second pouches 42 and 44 are preferably lined with felt, silk or other material which will not scratch the portable electronic device stored therein. A removable clip extension 32 extends from the pouch member 14, such as from the upper edge of the first pouch 42, and is provided for releasably securing an appropriately sized item, such as a flash memory drive, a key chain, or a student identification card using clasp 34. The clip extension 32 is removable, as may be required by the user, by releasing the fastening member 36 from the locked position. According to a preferred embodiment, the pouch member 14 includes two securing straps 40, each having first and second portions that are releasably attachable using a first segment 54 of a hook and loop fastener on the first portion and a second mating segment 56 of the hook and loop fastener on the second portion. The securing straps 40 are sized for securing the pouch member 14 and the folder member 12 to the cover 100 of a binder 102. It is preferable that the securing straps 40 be at least partially elastomeric.

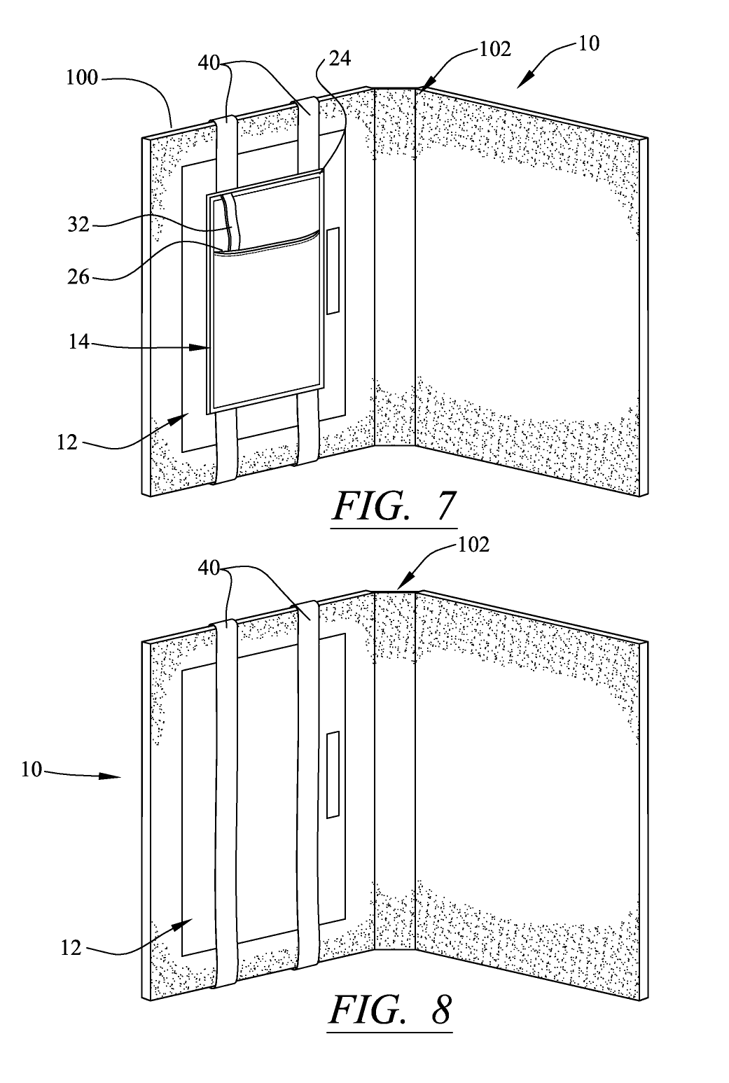

Referring to FIG. 7, the folder member 12 and pouch member 14 are securely fastened to the inner facing side of the cover 100 of the binder 102. As illustrated, it is preferable that the folder member 12 be positioned such that the opening 18 of the interior pocket 20 is facing the closed portion of the binder 102 rather than the open portion for preventing inadvertent removal of the contents from pocket 20. The pouch member 14 is positioned on top of folder member 12 and the securing straps 40 are securely fastened around the cover 100 of the binder, thereby holding the folder member 12 and pouch member 14 in place. As shown, the clip extension 32 (and attached item) may be stored inside second pouch 44.

Referring to FIG. 8, the harness 10 is configured such that the folder member 12 is secured to the inner facing side of the cover 100 and the pouch member 14 is secured to the outer facing side of the cover 100. Other configurations (not shown) of the harness 100 include both the folder member 12 and pouch member 14 being secured to the outer facing side of the cover, and the folder member 12 being secured to the outer facing side when the pouch member 14 is secured to the inner facing side of the cover 100.

In each embodiment of the harness 10, the folder member 12 and pouch member 14 may be made of any suitable material for securely holding portable electronic devices. Preferred materials include leather, cotton and nylon.

While the present invention has been shown and described in accordance with preferred and practical embodiments thereof, it is recognized that departures from the instant disclosure are contemplated within the spirit and scope of the present invention which is limited only by the following claims as interpreted by the Doctrine of Equivalents.

What is claimed is:

1. A harness for holding at least one electronic device on the cover of a notebook binder, and said harness comprising:
a folder member having an interior pocket sized and configured for enveloping the electronic device, said interior pocket being accessible through an at least partially resealable opening on said folder member, and said folder member having a front cover that is at least partially transparent for viewing the electronic device secured therein;
a pouch member having at least one interior storage compartment, said at least one interior storage compartment being at least partially resealable, and said at least one interior storage compartment being sized and configured simultaneously securing a plurality of electronic and non-electronic items;
at least one fastener for releasably securing said pouch member to said folder member;
at least one securing strap on said folder member, and said at least one securing strap being structure and disposed for releasably securing said folder member to the front cover of the notebook binder; and
whereby said pouch member may be moved from a first position to a second position, wherein the first position is defined by the pouch member being adjacent to the front cover of said folder member and the second position is defined by the pouch member being rotated about said at least one fastener and away from said folder member such that the front cover of said folder member is exposed for viewing the electronic device stored therein.

2. The harness as recited in claim 1 wherein said at least partially transparent front cover of said folder member comprises a material structured and disposed for allowing operation of a touch screen interface on the electronic device stored therein.

3. The harness as recited in claim 1 wherein said interior pocket of said folder member is sized and configured to snuggly receive an electronic tablet computer.

4. The harness as recited in claim 1 wherein said at least one interior storage compartment of said pouch member includes a zipper for at least partially resealing said at least one interior storage compartment.

5. The harness as recited in claim 1 wherein said at least one interior storage compartment of said pouch member includes a hook and loop fastener for at least partially resealing said at least one interior storage compartment.

6. The harness as recited in claim 1 wherein said at least one fastener for releasably securing said pouch member to said folder member comprises a hook and loop fastener.

7. The harness as recited in claim 1 wherein said at least one fastener for releasably securing said pouch member to said folder member comprises a snap fastener.

8. The harness as recited in claim 1 wherein said at least one securing strap comprises at least one elastic band structured and disposed for wrapping around the front cover of the notebook binder for securing the folder member adjacent to the front cover.

9. The harness as recited in claim 1 wherein each of said at least one securing straps comprises a first strap portion and a second strap portion, and said first and second strap portions being releasably attachable using a first segment of a hook and loop fastener on the first strap portion and a second mating segment of the hook and loop fastener on the second strap portion.

10. The harness as recited in claim 1 further comprising a removable clip extension attached to said pouch member, and said removable clip extension including a clasp at a first end and a fastening member at an opposite end for easy detachment of the clip extension from the pouch member.

11. A harness for holding at least one electronic device on the cover of a notebook binder, and said harness comprising:
a folder member having an interior pocket sized and configured for enveloping the electronic device, said interior pocket being accessible through an at least partially resealable opening on said folder member;
a pouch member having at least one interior storage compartment, said at least one interior storage compartment being at least partially resealable, and said at least one interior storage compartment being sized and configured simultaneously securing a plurality of electronic and non-electronic items;
at least one securing strap on said pouch member, and said at least one securing strap being structure and disposed for releasably securing said pouch member to the front cover of the notebook binder; and
whereby said folder member is sized and configured to be secured between the front cover of the notebook binder and said at least one securing strap.

12. The harness as recited in claim 11 wherein said interior pocket of said folder member is sized and configured to snuggly receive an electronic tablet computer.

13. The harness as recited in claim 11 wherein said at least one interior storage compartment of said pouch member includes a zipper for at least partially resealing said at least one interior storage compartment.

14. The harness as recited in claim 11 wherein said at least one interior storage compartment of said pouch member includes a hook and loop fastener for at least partially resealing said at least one interior storage compartment.

15. The harness as recited in claim 11 wherein said at least one securing strap comprises at least one elastic band structured and disposed for wrapping around the front cover of the notebook binder for securing the pouch member adjacent to the front cover of the notebook binder.

16. The harness as recited in claim 11 wherein each of said at least one securing straps comprises a first strap portion and a second strap portion, and said first and second strap portions being releasably attachable using a first segment of a hook and loop fastener on the first strap portion and a second mating segment of the hook and loop fastener on the second strap portion for securing the pouch member adjacent to the front cover of the notebook binder.

17. The harness as recited in claim 11 further comprising a removable clip extension attached to said pouch member, and said removable clip extension including a clasp at a first end and a fastening member at an opposite end for easy detachment of the clip extension from the pouch member.
